(19) United States
(12) Patent Application Publication
(10) Pub. No.: US 2022/0076215 A1
(43) Pub. Date: Mar. 10, 2022

(54) A METHOD AND SYSTEM FOR PROVIDING INFORMATION FROM SMART CONTAINERS

(71) Applicant: XORRO PTY LTD, Mt Hawthorn, Western Australia (AU)

(72) Inventors: Len LUXFORD, Mt Hawthorn, Western Australia (AU); Stephen Paul ASHER, Mt Hawthorn, Western Australia (AU)

(73) Assignee: XORRO PTY LTD, Mt Hawthorn, Western Australia (AU)

(21) Appl. No.: 17/283,889

(22) PCT Filed: Oct. 10, 2019
(86) PCT No.: PCT/AU2019/051100

§ 371 Date: Apr. 8, 2021

(30) Foreign Application Priority Data
Oct. 10, 2018 (AU) 2018903828

(51) Int. Cl. G06Q 10/00; B65F 1/14; G01G 19/414; G01G 19/52

(52) U.S. Cl. CPC G06Q 10/30; B65F 1/1484; G01G 19/414; G01G 19/52; B65F 2210/184; B65F 2210/168; B65F 2210/128; B65F 2210/138; B65F 2210/1443

(57) ABSTRACT

A method for processing information from smart containers for use by trading systems comprises passing sensor data through a model in which it is converted into a standard form, in an accessible location, from which it can be consumed.

### FIELD OF THE INVENTION

The present invention provides a method for processing information from smart containers for use by one or more downstream systems, such as trading systems.

### BACKGROUND

Smart containers such as networked connected litter/waste bins include sensors that provide information about their contents to a computer network. That information might include information about the contents of the container, such as weight and/or type of waste in the container, and events such as emptying of the container.

Such information can be used for waste collection management and collection routing. Once collected, the waste from multiple bins is combined into a bulk form for processing. Currently the event of collection of the waste is understood only to be used in relation to the collection routing, compliance and management purposes.

The present invention has been developed in this context.

Any references to documents that are made in this specification are not intended to be an admission that the information contained in those documents form part of the common general knowledge known to a person skilled in the field of the invention, unless explicitly stated as such.

### SUMMARY OF THE PRESENT INVENTION

According to an aspect there is provided a waste content predictive system comprising a receiver of data from a plurality of smart containers, a processor for applying one or more models to the data so as to add content and transform the data into a sharable format; and an output for sharing the transformed data.

In an embodiment, the model takes bin fullness at the time of emptying or weight of the contents of the bin at the time of emptying and is able to predict the types and amounts of content of each bin. In an embodiment, the model takes a type of waste each bin is designated to receive and predicts the types and amounts of content of each bin. In an embodiment, there are a plurality of types of waste that each bin is designated to receive. For example, the bin type may be one of: glass (this may be broken down in to clear glass and coloured glass), paper/cardboard, plastics, metal (such as aluminium cans), garden waste, and general household waste.

In an embodiment, the processor is configured to add content to the transformed data. In an embodiment, the added content is received by the processor (including from a source that is not the container). In an embodiment, the added content comprises information obtained from places at which the waste is transported subsequent to collection from each respective container. In an embodiment, the added content comprises information added at a later point in time than the time at which data is received from a respective one or more of the containers. In an embodiment, the added information relates to combining of collected waste from a plurality of containers. In an embodiment, the added content comprises information related to subsequent handling of the waste collected from each respective container. For example, the added content may be an amount of contamination (eg plastic bottles in the aluminium can container, or coloured glass in a clear glass container), or conversely a “purity” measure. In another example the added content may be weight, particularly if only volume (or an indicator of volume) is obtained from the container. For example, the collected material from a number of bins may under go a preliminary contamination screening and a percentage of contamination is identified or removed from the bulk material collected, before transportation for further processing (eg burial in land fill, incineration, or recycling).

In an embodiment, the output stores the transformed data for access by another system.

In an embodiment, the model is adapted by accounting for the actual contents of each bin over time. For example, the model may become improved in accuracy of its prediction over time by learning from feedback of the actual content in the container, or by averaging the actual content of a plurality of containers over time.

In an embodiment, the transformed data is stored in an immutable manner. In an embodiment, the transformed data is stored in a blockchain. Immutability becomes useful when the shared information is publicly available, but it used in a trading platform. Such a public ledger should not be able to be varied, but also needs to be publicly accessible, and may not be able to be achieved in a closed or proprietary environment.

Models are available or can be created to allow factors such as the carbon cost of a given mass of domestic waste or public waste for each type (eg. general, recyclable, paper, cans, glass etc.) to be calculated. Thus, for a given volume or weight of waste, the model can be used to infer the amount of waste in each category of composition of the waste, particularly when the types of waste is mixed. In an embodiment the fossil carbon content is predicted. In an embodiment the greenhouse gas content is predicted.

Standards exist that enable and can be used for emissions information to be normalised, so it can be shared. For example, ISO 14064 (the contents of which are incorporated herein by reference) is an international standard for quantifying and reporting greenhouse gas emissions (to the atmosphere) and reductions (to carbon sinks).

Trading schemes exist to limit and control environmental factors. For example, carbon trading schemes—sometimes called emissions trading—are market-based tools to limit greenhouse gas emissions. For example, the carbon market trades emissions under cap-and-trade schemes or with credits that pay for emissions or incentivise reductions. Other schemes include straightforward carbon taxes, and intracompany credit trading arrangements.

In an embodiment, the storage of the transformed data is arranged to be assessed by a system that monitors for the storage of the transformed data. In an embodiment, the system that monitors for the storage of the transformed data monitors for a trigger condition to be met. In an embodiment, when the trigger condition is met the monitoring system triggers the execution of a smart contract. The smart contract may provide a credit for the collection of the waste or may require a payment for the collection of the waste, or both. The amount of the credit/payment may be as determined by a trading scheme.

Thus, the collection of waste from a bin may, via the waste content predictive system, be used to activate a credit/payment in a trading scheme, such as a carbon trading scheme, according to the predicted content of the bin, as at the instant of collection of the waste. Further this is able to be stored in an immutable manner, whereby allocating a credit/cost of the waste as it is collected, even though it may then be subsequently pooled into bulk collected waste.

According to another aspect there is provided a waste collection system comprising: a plurality of waste containers, each with a sensor to determine the amount of waste therein at the time of emptying of the container, and each having a transmitter for transmitting the respective amount;

a receiver for receiving the respective amounts from each waste container;
a processor for applying one or more models to the data so as to transform the data into a standard format so it can be shared; and an output for sharing the transformed data.

In an embodiment, the processor is configured to perform a data transformation procedure, in which raw information provided by sensors in smart containers is transformed using the models into the standard form that can be used by downstream systems.

According to an aspect there is provided waste content predictive method comprising receiving data from a plurality of smart containers, applying one or more models to the data so as to transform the data into a standard format so it can be shared; and outputting the transformed data.

In an embodiment the method further comprises measuring the contents of the waste container at the time of collection of the waste therein and transmitting the amount as the data. In an embodiment the method further comprises recording and transmitting the time of collection and/or an identifier of the container from which the collection is taken.

This can be an asynchronous, disconnected approach, in that data isn't provided directly to downstream systems, but left in a format that is determined by users of the method to be useful to those systems.

### DESCRIPTION OF DRAWINGS

Some embodiments of the present invention are illustrated and are not limited by the figures of the accompanying drawings, in which like references may indicate similar elements and in which:

FIG. 1 depicts a flow chart of an example of an embodiment of the present invention;

FIG. 2 shows a block diagram of a system according to an embodiment of the present invention;

FIG. 3 is an entity diagram; and

FIG. 4 is a schematic diagram showing the process of developing a heuristic model.

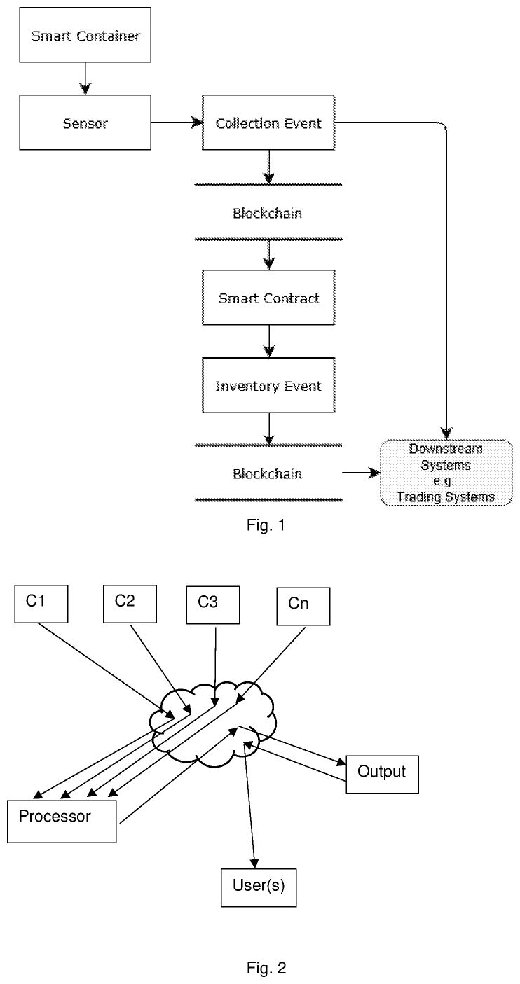

### DESCRIPTION OF EMBODIMENTS

The terminology used herein is for the purpose of describing particular embodiments only and is not intended to be limiting of the invention. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will be further understood that “computer systems” includes computer programs that execute on computer hardware. The computer program comprises instructions that control the operation of a processor and/or other devices of a computer(s) to execute the method required/configure the computer(s) to perform the functions of the required system.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention and is not intended to limit the invention to the specific embodiments illustrated by the figures or description below.

The present invention is generally a method for processing raw information from smart containers for use by, for example, trading systems, by receiving or otherwise acquiring the raw data, and then passing that data through a model, which configures a computational process to produce useful data (that is useful for the purpose of its consumption) from the raw data, and then transforms the useful data by a computational process in which it is converted into a standard form, in an accessible location, from which it can be consumed. The method is able to be implemented by a system described further below.

The models may range from simple declarative formulae to complex rules based systems. A simple declarative model is described below (these numbers are hypothetical):
1. A typical mass of domestic waste may contain about ten percent fossil carbon as carbon dioxide.
2. A government department may publish the prevailing destination of Australian domestic waste by percentage in a webservice, e.g.
   a. 50% goes to landfill.
   b. 30% is burned.
   c. 20% is shipped elsewhere.
3. The emissions resulting from each destination may be estimated, e.g.:
   a. Landfill=100% removal from the atmosphere.
   b. Burning=90% emissions and 10% removals.
   c. Shipping is assumed to be carbon neutral.
4. By applying those estimates to the measured weight of a container as provided by a sensor event, it is possible to calculate the carbon cost of a collection event.
5. For example, using the previous ([hypothetical) information this model returns these results:
   A 10 kg container is emptied.
   2.4 kg net carbon is emitted:
      6.2 kg emissions.
      3.8 kg removals.

| Kg | | Emissions | Removals | Net |
|---|---|---|---|---|
| 5 | Landfill | 2.5 | 2.5 | 0 |
| 3 | Burned | 2.7 | 0.3 | 2.4 |
| 2 | Shipped | 1 | 1 | 0 |
| 10 | | 6.2 | 3.8 | 2.4 |

This embodiment of the present invention produces data that can be used in principle to support the input data requirements of any form of trading scheme, provided sufficient raw information and suitable models are present.

In preferred embodiments, the present invention uses models implemented as smart contracts in a blockchain, that apply rules provided by external sources, to raw information provided by smart bin sensors, to store greenhouse gas inventory information in a blockchain.

A smart contract is a self-executing contract with the terms of the agreement being directly written into lines of code, with both the agreement and results stored in a blockchain.

The following example is from the Industrial bc blockchain. Other blockchains can be used which may implement smart contracts differently. The Industrial bc implementation may change.

In this embodiment of the invention, the following C #code is compiled on a blockchain worker node using the Mono compiler:

{Mono}
using System;
using Ibc.Sender;
using Newtonsoft.Json;
class Program
{

const double _landfillCarbonPart = .4;
const double _burningCarbonPart = .4;
const double _shippingCarbonPart = .2;
const double _landfillCarbonCost = −.8;
const double _burningCarbonCost = 1;
const double _shippingCarbonCost = 0;
const double _fossilCarbonPart = .1;
static void Main(string[ ] args)
{

string sensor = args[0];
DateTimetime = Convert.ToDateTime(args[1]);
double sensorMass = Convert.ToDouble(args[2]);
double fossilCarbonMass = _fossilCarbonPart * sensorMass;
double landfillCarbonMass = fossilCarbonMass * _landfillCarbonPart;
double burningCarbonMass = fossilCarbonMass * _burningCarbonPart;
double shippingCarbonMass = fossilCarbonMass * _shippingCarbonPart;
double landfillCarbonCost = landfillCarbonMass * _landfillCarbonCost;
double burningCarbonCost = burningCarbonMass * _burningCarbonCost;
double shippingCarbonCost = shippingCarbonMass * _shippingCarbonCost;
double carbonCost = landfillCarbonCost + burningCarbonCost +

shippingCarbonCost;

SensorTransformation sensorTransformation = new

SensorTransformation(sensor, time, sensorMass, carbonCost);

string s = JsonConvert.SerializeObject(sensorTransformation);
CallResponse response = Methods.Post(

JsonConvert.SerializeObject(isoplanIsolationPlanView),
absoluteUri);

}

}
class SensorTransformation
{

string _sensor;
DateTime _time;
double _sensorMass;
double _carbonCost;
public SensorTransformation(string sensor, DateTime time, double sensorMass,

double carbonCost)
{

_sensor = sensor;
_time = time;
_sensorMass = sensorMass;
_carbonCost = carbonCost;

}
public virtual string Sensor
{

get { return _sensor; }
set { _sensor = value; }

}
public virtual DateTime Time
{

get { return _time; }
set { _time = value; }

}
public virtual double SensorMass
{

get { return _sensorMass; }
set { _sensorMass = value; }

}
public virtual double CarbonCost
{

get { return _carbonCost; }
set { _carbonCost = value; }

}

}
{Endmono}

This example code is simplified and lacks the data integrity controls of a live production program. The transformation is hardcoded, where in a live implementation the contract would likely consult a webservice for modelling information.

The code is executed when sensor data is sent to the blockchain address of the contract, with the weight of a bin from the raw sensor data being the argument. This results in a string like that below being written in a transaction to the Industrial be blockchain:
{“Sensor”:“23c6ce4e-8ed7-4643-89a6-626486944f8f”,“Time”:“2018-09-07T11:20:24.93923+08:00”,“SensorMass”:10.0,“CarbonCost”:0.0799999999999999 6}

That is, the sensor in a bin identified as “23c6ce4e-8ed7-4643-89a6-626486944f8f” was emptied at “2018-09-07T11:20:24.93923+08:00”, had a mass at the time of emptying of “10.0” and according to the prediction of the model has a carbon cost of “0.07999999999999996”.

An equivalent outcome could be achieved using the smart contracts of other blockchains, with different code and potentially different logic.

In other embodiments, other forms of container, and other forms of model, and other agreed standards, and other forms of data store may be used.

In preferred embodiments, a typical sequence of events is:
1. A smart waste container is emptied into a city waste system.
2. The container sensor provides the weight (or volume and then inferred weight) of the contents.
3. The raw information is stored in a blockchain as a collection event.
4. A model stored in a smart contract in a blockchain transforms the collection event information into an inventory event in the blockchain in a format compliant with ISO 14064.

As an alternative, the data can be stored in a database and then, in the alternative the contract can be executed by accessing the transformed data, to for instance execute a trading scheme trade, which in turn may be stored in a database. The database may be operated by a trusted trading entity.

One purpose of this method is to create a permanent record of transactions. An advantage of a blockchain smart contract is that it is subject to the same premise of immutability as other blockchain data. This immutability attribute means a trusted entity is not required. Whether a blockchain smart contract or some other method for the transformation is used depends on how far the principle of blockchain immutability is desired to extend. That is, should it extend: to raw sensor data, or to the transformed data produced. A purely blockchain solution provides the greater immutability. A hybrid solution can exchange immutability for efficiency. Similar considerations apply to visibility. The greatest visibility will have uncompiled C #code in the blockchain.

In other embodiments, other containers, other measurements, other implementations of models, and other data stores may be used. For example:
A model may be provided by a third party using a service.
Collection events may be stored in a blockchain and inventory events in a database.
Events may be stored in a blockchain for immutability and duplicated in a database, for efficient access.

Blockchains include the concept of oracles, which are off-chain data sources, such as websites or webservices. In the above code, the constants in the model could instead be read by the smart contract code from a webservice. The webservice could then be considered to be providing the model. Taking that further, the smart contract could pass the sensor data (such as mass of waste emptied) to a webservice, and receive a string back (representing the predicted contents of the bin), to store in the blockchain.

The best approach to take depends on the specific requirements of implementation. Models that change rarely might be best stored in the blockchain. Models that change often might be best provided by a service. Models controlled by external parties are the most likely to be provided by some kind of service.

One capability of the method is the immutability of (collection) events: to provide a record for the future, that are impractical to be erased by others. Whether to extend this approach to transformed data is necessarily a trade-off. Widely shared blockchain data is considered to be less mutable than data in a database.

However, current databases are more efficient. Speed of processing might therefore argue for a database to be used for the retrieval of inventory events. In the future, as blockchain databases improve, the information retrieval practicalities may lean further towards blockchains.

The events can be stored in a publicly accessible manner, such as plain text, if it is desired for third party verification or information access, or it can be stored in an encrypted manner if it is desired for it to be confidential with only authorised access. Further, private and public blockchains can be used, again depending on which suits the specific implementation better.

In preferred embodiments, downstream systems are trading systems.

In other embodiments, downstream systems may be other types of systems, or consumers other than systems, such as humans reading a blockchain.

In preferred embodiments, this is an asynchronous, disconnected approach, in that data isn't provided directly to downstream systems, but left in a format that is determined by users of the method to be useful to those systems.

Downstream users are typically also abstracted. They collect the data the system produces in an asynchronous and disconnected manner. The output may be in the form of an interface. By plugging in different standards, we meet the needs of different users. For a carbon trading system, the data would typically be formatted according to ISO 14064.

The same approach (collect raw data from sensors, transform it into a standard form using a model, and store it somewhere widely accessible) can be used to provide information usable by any trading system, or indeed any system, provided a standard data definition exists.

For example, wholesale electricity is traded. The rules governing that market are contained in market regulations that could be implemented in smart contracts. In a hypothetical case, information about electricity to be sold could be put in the blockchain, where buyers can find it. Waste collected which can be used to fuel a waste power generation plant can be provided with power credits according to the volume/weight of waste fuel for such a plant.

Counterparties make trades by sending information to smart contracts which result in information required by regulators. Thus, intermediaries are discouraged, which can result in an open, asynchronous, disconnected market for wholesale electricity.

The availability of an output can be signalled to a potential consumer that data is there to be retrieved. The signalling mechanism could be an electronic communication.

Once a record of the collection is created the waste can be attributed with a cost and or a value. In the case of the value this is what can be traded when the waste is transferred from one “owner” to another. In tracking this value (or cost) further entries in (additions to) the database or blockchain can be made. In particular when operating with blockchains it is undesirable to change a record, but rather add to it, even if a correction, splitting or pooling.

ISO 14064 defines an inventory as the sum of movements of gases to and from stores and the atmosphere. Any transaction transformed from sensor data may have to be added to by changes in any of those variables, thus adding new content to information already in the inventory.

Some examples are:
Factual errors might need to be corrected. A provider might estimate an equal movement of gases in a quantity of waste to landfill and combustion in a transaction. An audit may find that all those gases went to carbon storage. That could result in multiple corrections: to the type of the stores; to the masses emitted and removed; and to the margin of error.
Research findings feeding into estimates might change. A provider might begin with an assertion of the types of gases emitted (e.g. that undifferentiated municipal solid waste in landfill contains 10% fossil carbon released as CO2) then new research might emerge (e.g. that landfill also releases CH₄ and N₂O) that causes a correcting transaction to be made.
Double counting might be discovered, where for whatever reason multiple providers make assertions for the same waste, causing a correcting transaction to be made.
System errors might be discovered, either in sensors or algorithms, causing a correcting transaction to be made.
The standards might change, causing new information to be added to existing inventory information.
The interpretation of the standards might change, causing new information to be added to existing inventory information.
A carbon tax, trading scheme or other mechanism might emerge that requires new information to be added to existing inventory information.
The margin of error of past estimates might change, based on new information.

Because a blockchain cannot be mutated, this invention treats inventory transactions in the blockchain as additive, with new transactions in some cases adding new information to existing transactions, or superseding them entirely.

Referring to FIG. 2, there is a system for implementing embodiments of the method described above. The system comprises a plurality of smart containers C1, C2, C3 to Cn, each having a sensor for detection of the level of waste in the container at least at the time of emptying of the container and communication device for transmitting this data via a computer network, such as for example, the internet. This “reading” may be taken continuously/polled and the last measurement used when the level is reset to “empty”, for the event of emptying may trigger a reading. The event may trigger reporting by the smart container to a “central system” which comprises a processor. Alternatively, the level may be recorded by the smart container and is queried by the processor. Instead of the level of waste at the time of emptying, the mass of the waste may instead be used.

On an as needed basis, or batch basis, or other suitable basis the processor performs transformations of each of the data from the containers C1 to Cn. Each of these transformed data is then “saved” to an output. Typically, the output will be an internet based storage location that can be accesses as needed by one or more users. More specifically the internet based storage location may be in a database or in a blockchain, according to the implementation desired.

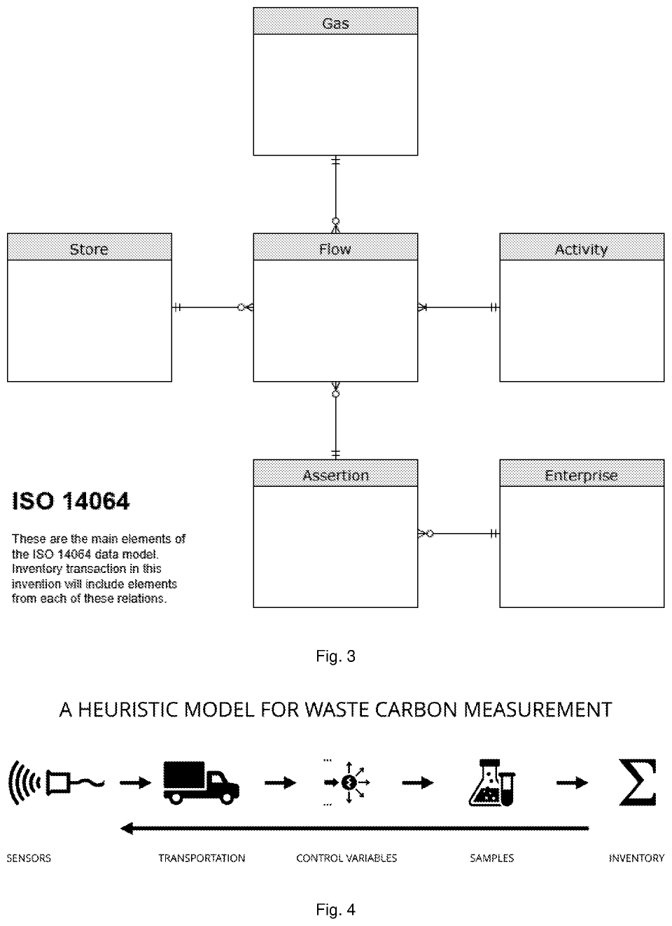

FIG. 3 is an entity diagram reflecting the data model in ISO 14064. In a preferred embodiment the transformed data comprises elements in each of flow, gas, store, activity, assertion and enterprise data types, with a zero or many to one and only one foreign key relationship as shown.

Following is a C #data class, representing the main flow object in an ISO 14064 data store:

public class Flow
{

public int id { get; set; }
public int direction { get; set; } // Pointer to a Direction reference table
public int gas { get; set; } // Pointer to a Gas table
public int activity { get; set; } // Pointer to an Activity table
public int assertion { get; set; } // Pointer to an Assertion table, In ISO 14064,

an assertion is a declaration by an enterprise that flows have occurred

public decimal estimatedMass { get; set; }
public decimal actualMass { get; set; }
public decimal plannedMass { get; set; }
public int store { get; set; } // Pointer to a Store table. For example,

atmosphere, sink.
}

Below is a C #code sample that shows how a data abject is serialised and stored in the blockchain, using Industrial bc:
Flow flow=new Flow(direction, gas, activity, assertion, estimatedMass, actualMass, plannedMass, store);
string post=JsonConvert.SerializeObject(flow)//Convert Flow to a JSON string
Industrialbc.Sender.Methods.Post(post);

The invention includes the concept of models, stored in the blockchain or elsewhere. These models comprise of rules encoded in logic for transforming sensor data into a form usable by disconnected consumers, such as downstream computer systems.

Some modifications or adaptions to the examples described above are as follows:

### Sensor Adaptions

Sensor data is the primary input into models. Sensors may change over time to provide improved data. For example, consumer bin technology currently estimates weight based on volume. The default model for an instance of the invention might be based on a readout of volume. This could be stored as a smart contract in the blockchain. Bin collection events might then produce inventory events using that smart contract. The collection event is linked to the smart contract and the resulting inventory event by their unique blockchain addresses.

This is already an improvement over weight being calculated based on the volume of waste in the bin, since in the event that weight to volume ratios change, a new smart contract is easier to implement than changes to the sensors in all of the bins. What could happen in practise is that a new smart contract would be stored in the blockchain, and its unique address added to the bin management system. This is one example of a model adaptation.

Say that bins are upgraded to measure weight directly. Now a smart contract can be stored that accepts weight as an input directly, and its unique address added to the bin management system.

Say the objective of the model is to inventory fossil carbon. Say that in the future a bin is developed that measures carbon directly. Again, a smart contract can be stored that accepts inventory measurements as an input directly, and its unique address added to the bin management system.

### Consumer Adaptations

Some of the information required for model transformations may come from external data sources. Say the default model for a use case begins with an estimate that waste goes by percentage of mass to certain locations, based on historical measurements. Those percentages might be hardcoded into the model to begin with.

Now say that a consumer of the information is able to provide better metrics. Examples of improvements might be:
Real measurements of the mass that goes to locations.
In the case of carbon, real measurements of the carbon cost of a location.
In the case of endpoint locations, opening up the network to provide further endpoints. For example, a port of departure in New York might become waste management facilities in China, each with their own metrics.

In this system, accommodating these improvements, with the goal of providing better information, can be achieved by new smart contracts, stored in the blockchain.

### Error Margins

No physical measurement is perfect. This invention is designed to adapt to improving measurements over time. To facilitate this, estimates of the error range of inputs must be provided. In the case of ISO 14064 for carbon, this forms part of the standards.

For example, domestic waste might be considered to contain 10% fossil carbon by weight with +/−10% accuracy. In some collection locations, the error band might be wider than this, and in others it might be narrower than this. In this invention, error margins can be added by models, based on factors such as location, or downstream measurements, independently of the sensor.

For example, say a certain model predicts that bins in a certain location will contain 1 g per cc of volume. Say downstream weighing shows the real weight of the accumulated waste to be between 0.75 and 1.25 g per cc of volume. The model's confidence interval is 0.5 g. Its error margin is 1 g+/−25%. These margins can be included in the results of transformations, and thus contribute to the improvement of models over time, using the mechanism of blockchain smart contract replacement. They can also indicate to consumers how accurate the data is likely to be.

### Oracles

Some information is hardcoded into models. An example is the 10% fossil carbon by weight of domestic waste, which is based on research. (Blomqvist E and Jones F, SP Technical Research Institute of Sweden. Determination Of The Fossil Carbon Content In Combustible Municipal Solid Waste In Sweden Rapport u2012:05 ISSN 1103-4092. http://www.cewep.eu/wp-content/uploads/2017/10/fossil_carbon_in_waste 2012.pdf. Accessed Dec. 9, 2018). Other inputs might be obtained dynamically, from external sources. In blockchain terms, these are called Oracles.

These could include (but are not limited to):
Interfaces with external systems.
Webservices.
Websites [e.g. by screen scraping techniques]
   For example, a city might choose to publish in a webservice the most recent breakdown of collected waste into landfill, burning and shipping destinations. This could be an input to a model. It could also be used as information to improve the performance of models, using the mechanism of blockchain smart contract replacement.

In an aspect of the invention the model is heuristic. Heuristic means an approach to problem solving, learning, or discovery that employs a practical method not guaranteed to be optimal or perfect, but sufficient for the immediate goals. Data form the sensors is combined with control variables and statistical samples in a computational model to approximate the carbon cost of bin events without knowing their contents.

This heuristic model has the capacity to improve over time. For example, we currently extrapolate the mass of bin contents at emptying events by applying a control variable to the mass of the waste in a bin, measured by a sensor. We then model the flow of the waste to the point of disposal, and from that estimate the carbon cost of the process.

As better sensors become available, they can plug into the process, allowing future extrapolations to be more accurate. In our solution, we simply plug the new sensor into the process. In the future, additional sensors can be added to produce better and/or richer data, such as carbon sniffing sensors. Being heuristic, the model is at least in part self adapting.

At the other end of the data flow, either an algorithm or a control variable can be added for each destination, with differing degrees of granularity. An emissions profile of an individual landfill can be plugged in to create scenarios for any waste flow.

Thus using a heuristic model enables plugging in any sensor and the system learns over time, by the addition of new inputs and outputs, and new transport algorithms, each of which may have an emissions profile, as exemplified by FIG. 4. Notably the right to left arrows represents leaning over time of the heuristic model.

Further as the model is able to breakdown data into sensor, transport and outcome and learn relationships between these over time, a general model can be applied to any waste flow, which then maps to a flow of gases to or from the atmosphere.

### A Use Case

In this example, a waste volume sensor provides information to a greenhouse gas inventory system using the model.

A sensor is built into a container, such as a public municipal bin, providing an input.

The conversion of solid municipal waste from volume to mass is derived by experimentation, providing a control variable.

The transport of waste from the input to one or more destinations is analysed, providing a statistical model.

The emissions profile of each destination is analysed, providing a control variable.

The volume of waste in the bin is processed by the statistical model using the input and the control variable to produce an output, in terms of gases emitted to the atmosphere.

The process is carried out, each time the bin is emptied.

For example:

Bin X contains 10 k litres of municipal solid waste.

The waste is collected.

This converts to 1 tonne of mass.

This is always transported to landfill site A.

Landfill site A emits 1 kg of methane and 1 kg of carbon dioxide per tonne of municipal solid waste, based on a statistical sample.

The collection event emitted 1 kg of methane and 1 kg of carbon dioxide to the atmosphere.

This method can be extended by any number of inputs, control variables end samples.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1. A waste content predictive system comprising a receiver of data from a plurality of smart containers, a processor for applying one or more models to the data so as to transform the data into a standard format so it can be shared; and an output for sharing the transformed data.

2. A system according to claim 1, wherein the model takes bin fullness at the time of emptying or weight of the contents of the bin at the time of emptying and configured to predict the types and amounts of content of each bin.

3. A system according to claim 1, wherein the model takes a type of waste each bin is designated to receive and predicts the types and amounts of content of each bin.

4. A system according to claim 1, wherein the processor is configured to add content to the transformed data.

5. A system according to claim 4, wherein the added content is received by the processor.

6. A system according to claim 4, wherein the added content comprises information obtained from places at which the waste is transported subsequent to collection from each respective container.

7. A system according to claim 4, wherein the added content comprises information added at a later point in time than the time at which data is received from a respective one or more of the containers.

8. A system according to claim 4, wherein the added information relates to combining of collected waste from a plurality of containers.

9. A system according to claim 4, wherein the added content comprises information related to subsequent handling of the waste collected from each respective container.

10. A system according to claim 1, wherein the output stores the transformed data for access by another system.

11. A system according to claim 1, wherein the model is adapted by accounting for the actual contents of each bin over time.

12. A system according to claim 10, wherein model is adapted to improve accuracy over time, and/or to adapt to changes in input over time.

13. A system according to claim 1, wherein the transformed data is stored in an immutable manner.

14. A system according to claim 1, wherein the transformed data is stored in a blockchain.

15. A system according to claim 1, wherein the storage of the transformed data is arranged to be assessed by a system that monitors for the storage of the transformed data.

16. A system according to claim 1, wherein the system that monitors for the storage of the transformed data monitors for a trigger condition to be met.

17. A system according to claim 16, wherein when the trigger condition is met the monitoring system triggers the execution of a smart contract by sending information to a computer network location.

18. waste collection system comprising:
a plurality of waste containers, each with a sensor to determine the amount of waste therein at the time of emptying of the container, and each having a transmitter for transmitting the respective amount;
a receiver for receiving the respective amounts from each waste container;
a processor for applying one or more models to the data so as to transform the data into a standard format so it can be shared; and an output for sharing the transformed data.

19. A waste content predictive method comprising receiving data from a plurality of smart containers, applying one or more models to the data so as to transform the data into a standard format so it can be shared; and outputting the transformed data.
